(19) United States
(12) Patent Application Publication
(10) Pub. No.: US 2013/0330653 A1
(43) Pub. Date: Dec. 12, 2013

(54) Novel PPS-S Membrane

(71) Applicants: James Mitchell, Bloomfield, NY (US); Lijun Zou, Rochester, NY (US); Timothy J. Fuller, Pittsford, NY (US); Gerald W. Fly, Geneseo, NY (US)

(72) Inventors: James Mitchell, Bloomfield, NY (US); Lijun Zou, Rochester, NY (US); Timothy J. Fuller, Pittsford, NY (US); Gerald W. Fly, Geneseo, NY (US)

(73) Assignee: GM Global Technology Operations LLC, Detroit, MI (US)

(21) Appl. No.: 13/492,387

(22) Filed: Jun. 8, 2012

(51) Int. Cl. C08G 75/14; H01M 8/04; H01M 8/10

(52) U.S. Cl. 429/483; 521/27; 429/492

(57) ABSTRACT

A method for making hollow metal tubes includes a step combining a polyphenylene sulfide-containing resin with a water soluble carrier resin to form a resinous mixture. The resinous mixture is then extruded to form an extruded resinous mixture. The extruded resinous mixture includes polyphenylene sulfide-containing fibers within the carrier resin. The extruded resinous mixture is contacted (i.e., washed) with water to separate the polyphenylene sulfide-containing fibers from the carrier resin. The polyphenylene sulfide-containing fibers are then formed into a membrane.

The present invention relates to methods for making hollow metal nanotubes.

### BACKGROUND OF THE INVENTION

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). Proton exchange membrane (“PEM”) fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Typically, the ion conductive polymer membrane includes a perfluorosulfonic acid (PFSA) ionomer.

Each catalyst layer has finely divided catalyst particles (for example, platinum particles), supported on carbon particles, to promote oxidation of hydrogen at the anode, and reduction of oxygen at the cathode. Protons flow from the anode through the ion conductive polymer membrane to the cathode where they combine with oxygen to form water which is discharged from the cell.

The MEA is sandwiched between a pair of porous gas diffusion layers (“GDL”), which in turn are sandwiched between a pair of electrically conductive flow field elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

In many fuel cell applications, electrode layers are formed from ink compositions that include a precious metal and a perfluorosulfonic acid polymer (PFSA). For example, PFSA is typically added to the Pt/C catalyst ink in electrode layer fabrication of proton exchange membrane fuel cells to provide proton conduction to the dispersed Pt nanoparticle catalyst as well as binding of the porous carbon network. Traditional fuel cell catalysts combine carbon black with platinum deposits on the surface of the carbon, along with ionomers. The carbon black provides (in part) a high surface area conductive substrate. The platinum deposits provide a catalytic behavior, and the ionomers provide a proton conductive component. The electrode is formed from an ink that contains the carbon black catalyst and the ionomer, which combine on drying to form an electrode layer.

Although the current technologies for making the ion conducting membranes work reasonably well, there is still a need for improvement. For example, polyphenylene sulfide modified with the addition of sulfonic acid groups (ionmeric polyphenylene sulfide membrane) is available in sheet form, but is generally not available in thicknesses less than 25 um. Forming these membranes in thinner sheets is difficult. The addition of sulfonic acid groups may require the use of chlorosulfonic acid, a process that frequently creates uneven results and burn through spots.

Accordingly, the present invention provides improved methods of making porous pads that are useful in fuel cell applications.

### SUMMARY OF THE INVENTION

The present invention solves one or more problems of the prior art by providing in at least one embodiment a method for making a membrane. The method includes a step combining a polyphenylene sulfide-containing resin with a water soluble carrier resin to form a resinous mixture. The resinous mixture is extruded to form a shaped resinous mixture. The shaped resinous mixture has polyphenylene sulfide-containing structures within the carrier resin. The extruded resinous mixture is contacted with water to separate the polyphenylene sulfide-containing structures from the carrier resin. The polyphenylene sulfide-containing structures is then formed into a membrane.

In another embodiment, a method for making a membrane is provided. The method includes a step combining a polyphenylene sulfide-containing resin with a water soluble carrier resin to form a resinous mixture. The resinous mixture is then extruded to form an extruded resinous mixture. The extruded resinous mixture includes polyphenylene sulfide-containing fibers within the carrier resin. The extruded resinous mixture is contacted (i.e., washed) with water to separate the polyphenylene sulfide-containing fibers from the carrier resin. The polyphenylene sulfide-containing fibers are optionally sulfonated. The sulfonated polyphenylene sulfide-containing fibers are then formed into a membrane.

Advantageously, the processes set forth above provide allow for sulfonation to be achieved in a controlled and repeatable manner. The high surface area allows the entire mass of the polyphenylene sulfide-containing fibers to be processed evenly. Moreover, the small dimension of the fibers allows a thin mat to be laid down, and in turn, very thin membranes to be manufactured.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating a separator;

FIG. 2 is an idealized top view of a membrane made by a variation of the method set forth below;

FIG. 3 is a schematic flow chart showing the fabrication of a membrane using polyphenylene sulfide fibers;

FIG. 4A provides a scanning electron micrograph of a top view of a polyphenylene sulfide fibrous membrane;

FIG. 4B provides a scanning electron micrograph of a side view of a polyphenylene sulfide fibrous membrane; and

FIGS. 5A and 5B is a scanning electron micrograph of a sulfonated polyphenylene sulfide membrane with a thickness of approximately 7 microns at two magnifications.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refers to weight average molecular weight unless indicated otherwise; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

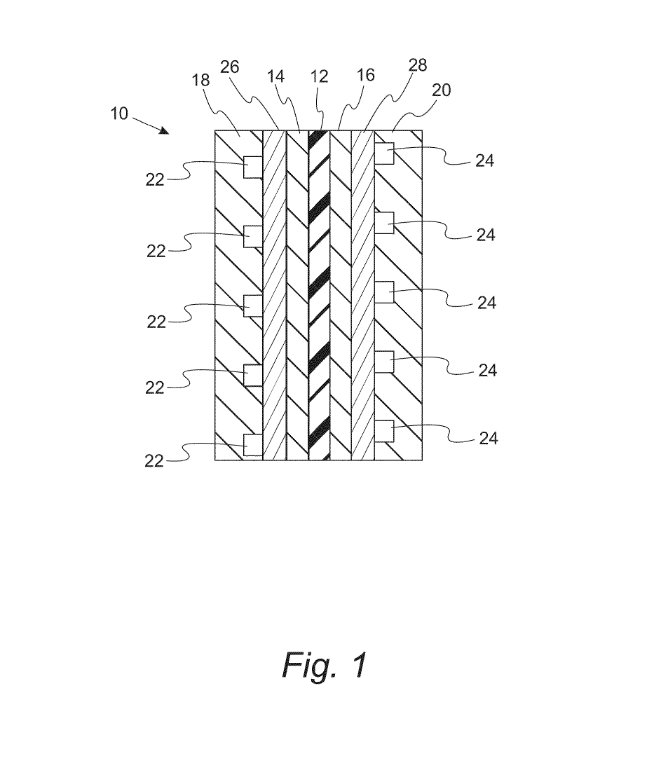

With reference to FIG. 1, a schematic cross section of a fuel cell that incorporates an embodiment of a fibrous sheet is provided. Proton exchange membrane (PEM) fuel cell 10 includes polymeric ion conducting membrane 12 disposed between cathode catalyst layer 14 and anode catalyst layer 16. Fuel cell 10 also includes flow field plates 18, 20, gas channels 22 and 24, and gas diffusion layers 26 and 28. Advantageously, polymeric ion conducting membrane 12 includes polyphenylene sulfide structures and in particular, polyphenylene sulfide fibers as set forth below.

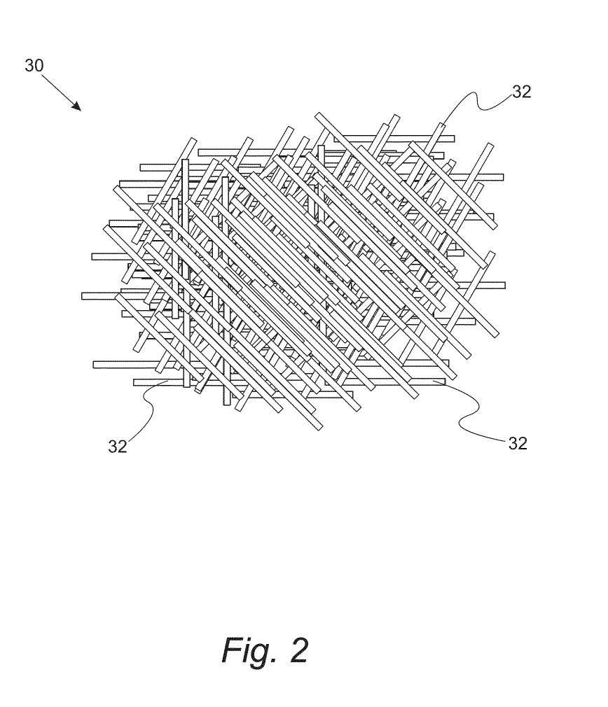

With reference to FIG. 2, an idealized top view of a polyphenylene sulfide fibrous membrane made by a variation of the method set forth below is provided. Membrane 30 is formed from a plurality of polyphenylene sulfide fibers 32 aggregated together to form a pad-like layer. Typically, polyphenylene sulfide fibers 32 have an average width from about 5 nanometers to about 30 microns. In another refinement, polyphenylene sulfide fibers 32 have an average width from about 5 nanometers to about 10 microns. In still another refinement, polyphenylene sulfide fibers 32 have an average width of from about 10 nanometers to about 5 microns. In still another refinement, polyphenylene sulfide fibers 32 have an average width of from about 100 nanometers to about 5 microns. In still another variation, polyphenylene sulfide fibers 32 have an average width of from about 50 nanometers to about 400 nm. In certain variations, polyphenylene sulfide fibers 32 are modified with protogenic groups and/or metal layers as set forth below.

In a variation of the present embodiment, membrane 30 has a thickness from about 5 microns to about 2 mm. In a refinement, membrane 30 has a thickness from about 5 microns to about 500 microns. In another refinement, membrane 30 has a thickness from about 5 microns to about 25 microns.

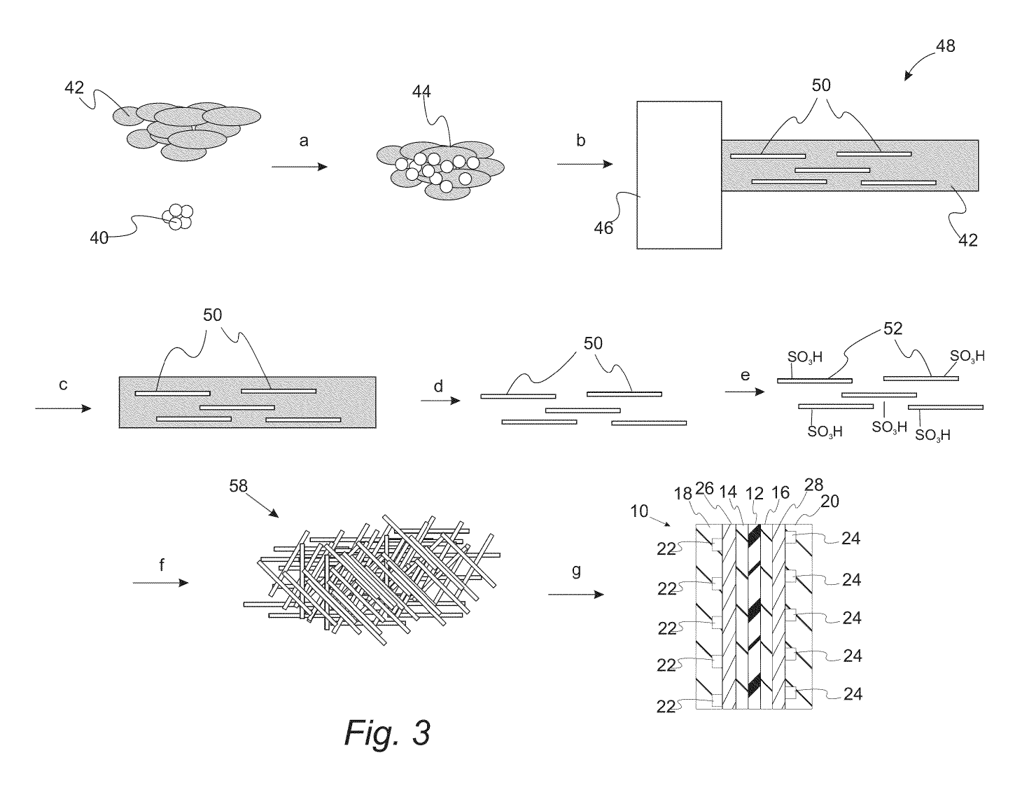

With reference to FIG. 3, a schematic flow chart illustrating a method for a polyphenylene sulfide-containing membrane is provided. In step a), polyphenylene sulfide-containing resin 40 is combined with water soluble carrier resin 42 to form resinous mixture 44. In a refinement, the weight ratio of polyphenylene sulfide-containing resin 40 to water soluble carrier resin 42 is 1:100 to about 10:1. In another refinement, the weight ratio of polyphenylene sulfide-containing resin 40 to water soluble carrier resin 42 is 1:50 to about 10:1. In still another refinement, the weight ratio of polyphenylene sulfide-containing resin 40 to water soluble carrier resin 42 is 1:10 to about 10:1. In step b), resinous mixture 44 is shaped. The shaping of the resinous mixture affects the shape of the polyphenylene sulfide-containing resin therein through the action of various forces (e.g., friction, shearing forces, etc.) transmitted to the polyphenylene sulfide-containing resin. FIG. 3 depicts a particular example in which resinous mixture 44 is extruded. Therefore, resinous mixture 44 is extruded from extruder 46 in step b) to form extruded resinous mixture 48. In other variations, the polyphenylene sulfide is in the form of beads, spheres, and oblong shapes. In a refinement of these variations, the polyphenylene sulfide has an average spatial dimension (e.g., a width) from about 5 nanometers to about 10 microns. Extruded resinous mixture 48 includes polyphenylene sulfide-containing fibers 50 within carrier resin 42. In step c), the extruded fiber is optionally separated from extruder 46. In step d), polyphenylene sulfide-containing fibers 50 are freed from the fiber by contacting/washing in water. In step e), protogenic groups (PG) are optionally added to the polyphenylene sulfide-containing fibers to form modified polyphenylene sulfide-containing fibers 52:

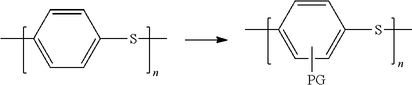

wherein PG is —SO₂X, —PO₃H₂, and —COX where X is an —OH, a halogen, or an ester and n is a number from about 20 to about 500 on average. In particular, the polyphenylene sulfide-containing fibers are sulfonated (SO₃H) in this step.

In step f), polyphenylene sulfide-containing fibers 50 or modified polyphenylene sulfide-containing fibers 52 are formed into membrane 58. In a refinement, membrane 58 is formed by pressing and heating of sulfonated polyphenylene sulfide-containing fibers 52. In another refinement, sulfonated polyphenylene sulfide-containing fibers 52 are combined with a solvent and an optional inomer (e.g., NAFION™ which is a PFSA polymer) and then coated out on a substrate to form membrane 58. In this latter refinement, suitable solvents include alcohols (e.g., methanol, alcohol, propanol, and the like) and water. In a variation, polyphenylene sulfide-containing fibers 50 or modified polyphenylene sulfide-containing fibers 52 are combined with a solvent as above and another ionomer and then coated out on a substrate to form a membrane. Examples of such ionomers include but are not limited to perfluorsulfonic acid ionomers such as NAFION™. In a refinement, the protogenic groups are added after the membrane is formed. In step g), cathode catalyst layer 14 and/or anode catalyst layer 16 are integrated into fuel cell 10.

As set forth above, the method of the invention utilize water soluble resins. Examples of suitable water-soluble resins include, but are not limited to, water-soluble polyamides (e.g., poly(2-ethyl-2-oxazoline) (“PEOX”). In a refinement, the PEOX has a number average molecular weight from about 40,000 to about 600,000. Number average molecular weights of 200,000 and 500,000 have been found to be particularly useful.

In a refinement of the present invention for the variations and embodiments set forth above, the polyphenylene sulfide fibers (with or without protogentic groups) have an average cross sectional width (i.e., diameter when the fibers have a circular cross section) from about 5 nanometers to about 30 microns. In another refinement, the fibers have an average width of about 5 nanometers to about 10 microns. In still another refinement, the fibers have an average width of from about 10 nanometers to about 5 microns. In still another refinement, the fibers have an average width of from about 100 nanometers to about 5 microns. The length of the fibers typically exceeds the width. In a further refinement, the fibers produced by the process of the present embodiment have an average length from about 1 mm to about 20 mm or more.

The following examples illustrate the various embodiments of the present invention. Those skilled in the art will recognize many variations that are within the spirit of the present invention and scope of the claims.

### EXAMPLE 1

Polyphenylene sulfide (PPS) thermoplastic fibers are first created by dispersing PPS in 500,000 molecular weight (weight average) water soluble polymer poly(2-ethyl-2-oxazoline) (PEOX). Specifically, 5 grams of PPS is first blended in a Waring blender with 15 grams of 500,000 molecular weight (MW) PEOX (a ratio of 1 to 3). The combined blend is added to a laboratory mixing extruder (Dynisco, LME) operated at 240° C. header and rotor temperatures with the drive motor operated at 50% of capacity, resulting in an extruded strand of the blend. This extruded strand is added to the blender to return it to granular form, and re-extruded two more times, creating a uniform extruded strand. During the final extrusion processes, the fibers are spun onto a take-up wheel (a Dynisco Take-Up System (TUS), at approximately 10 cm/second.

The resulting extruded strand is washed in reverse osmosis (RO) water with repeated rinses, until the PEOX has been removed, resulting in a sample of PPS nanofibers. The fibers are then rinsed in isopropyl alcohol and allowed to dry completely overnight.

### EXAMPLE 2

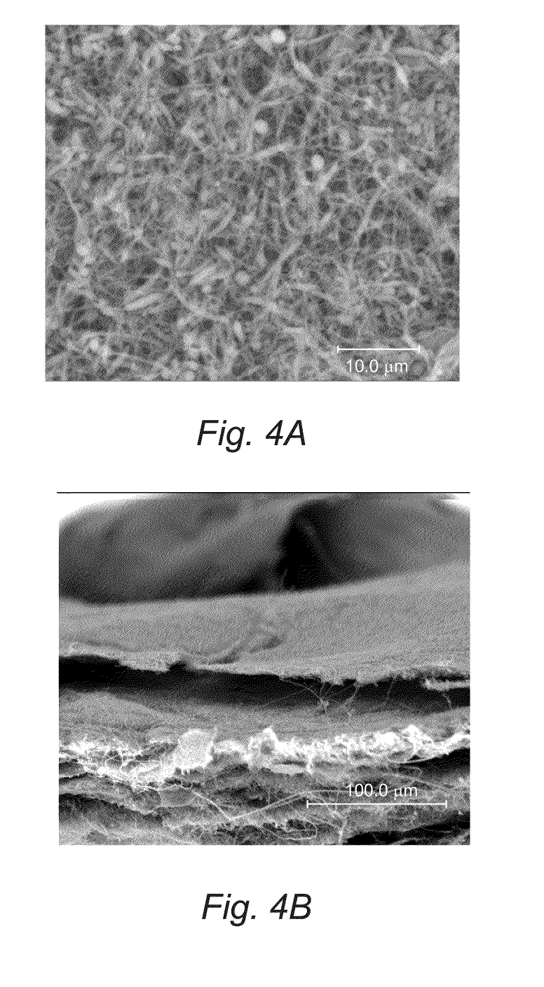

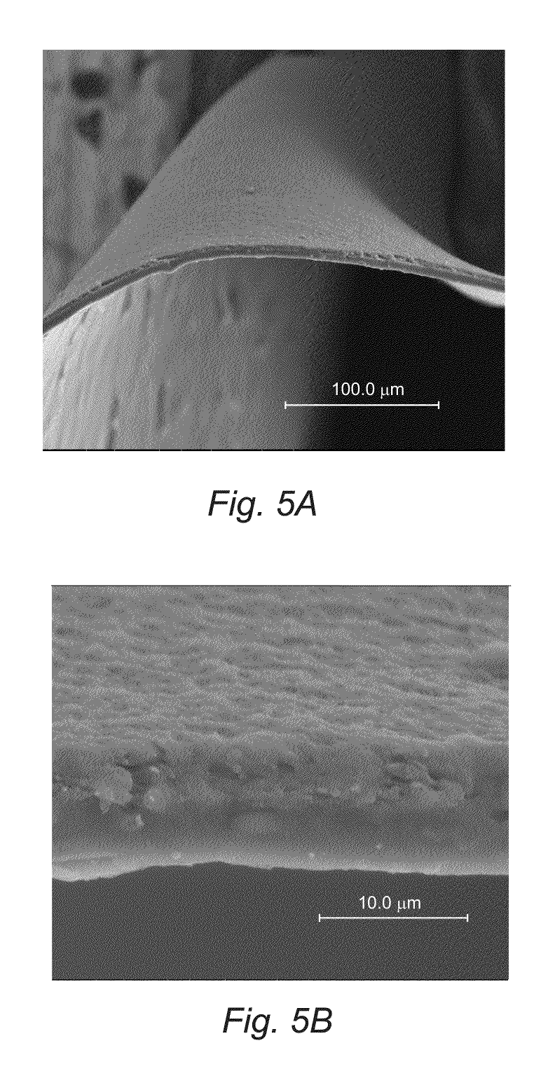

A mat of nano-fibers of poly(phenylene sulfide) (2 g, Example 1) is suspended in methylene chloride (50 g) in a screw-cap jar with a Teflon gasketed lid. Chlorosulfonic acid is first dispersed in methylene chloride (2 gram in approximately 10 g). With vigorous stirring, chlorosulfonic acid dispersion (2 g of acid) is added to the dispensation of PPS fibers in methylene chloride and the lid is secured. The jar is mixed for 4 hours and then the dark green-blue membrane is added to water (1 L) and is stirred for 16 hours. The resulting membrane is washed extensively with water while resting on a polypropylene mat (SeFar America). The reaction is repeated using three grams of chlorosulfonic acid and two grams of nanofibers of poly(phenylene sulfide). The resulting membrane of poly(phenylene sulfide) with sulfonic acid groups is referred in as PPS-S membrane. FIG. 4A provides a scanning electron micrograph of a top view of a polyphenylene sulfide fibrous membrane. FIG. 4B provides a scanning electron micrograph of a side view of a polyphenylene sulfide fibrous membrane. FIGS. 5A and 5B is a scanning electron micrograph of a sulfonated polyphenylene sulfide membrane with a thickness of approximately 7 microns at two magnifications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method comprising:
combining a polyphenylene sulfide-containing resin with a water soluble carrier resin to form a resinous mixture;
shaping the resinous mixture to form a shaped resinous mixture, the shaped resinous mixture having polyphenylene sulfide-containing structures within the carrier resin;
contacting the shaped resinous mixture with water to separate the polyphenylene sulfide-containing structures from the carrier resin; and
forming the polyphenylene sulfide-containing structures into a membrane.

2. The method of claim 1 wherein the polyphenylene sulfide-containing structures include a component selected from the group consisting of fibers, beads, spheres, and oblong shapes.

3. The method of claim 1 wherein protogenic groups are added to the polyphenylene sulfide-containing resin.

4. The method of claim 1 wherein the protogenic groups are SO₂X, —PO₃H₂, or —COX where X is an —OH, a halogen, or an ester.

5. The method of claim 1 wherein the carrier resin is a water-soluble polyamide.

6. The method of claim 1 wherein the carrier resin comprises poly(2-ethyl-2-oxazoline).

7. The method of claim 1 wherein the weight ratio of polyphenylene sulfide-containing resin to carrier resin is from about 1:10 to about 10:1.

8. The method of claim 1 wherein the polyphenylene sulfide-containing structures have an average spatial dimension from about 5 nanometers to about 10 microns.

9. The method of claim 1 wherein the membrane has an average thickness from about 5 microns to about 25 microns.

10. The method of claim 1 wherein the membrane is incorporated into a fuel cell.

11. A method comprising:
combining a polyphenylene sulfide-containing resin with a water soluble carrier resin to form a resinous mixture;
extruding the resinous mixture to form an extruded resinous mixture, the extruded resinous mixture having polyphenylene sulfide-containing fibers within the carrier resin;
contacting the extruded resinous mixture with water to separate the polyphenylene sulfide-containing fibers from the carrier resin;
sulfonating the polyphenylene sulfide-containing fibers;
forming the polphenylene sulfide-containing fibers into a membrane.

12. The method of claim 11 wherein the carrier resin is a water-soluble polyamide.

13. The method of claim 11 wherein the carrier resin comprises poly(2-ethyl-2-oxazoline).

14. The method of claim 11 wherein the weight ratio of polyphenylene sulfide-containing resin to carrier resin is from about 1:10 to about 10:1.

15. The method of claim 11 wherein the polyphenylene sulfide-containing structures have an average spatial dimension from about 5 nanometers to about 10 microns.

16. The method of claim 11 wherein the membrane has an average thickness from about 5 microns to about 25 microns.

17. A fuel cell comprising:
a first flow field plate;
a second flow field plate;
a first catalyst-containing electrode layer interposed between the first flow field plate and the second flow field plate;
a second catalyst-containing electrode layer interposed between the first flow field plate and the second flow field plate; and
an ion-conducting membrane interposed between the first catalyst layer and the second catalyst layer, wherein the ion conducting membrane includes polyphenylene sulfide-containing fibers.

18. The fuel cell of claim 17 wherein the polyphenylene sulfide-containing fibers have an average width from about 5 nanometers to about 10 microns.

19. The fuel cell of claim 18 wherein the polyphenylene sulfide-containing fibers are sulfononated.

20. The fuel cell of claim 17 wherein the membrane has an average thickness from about 5 microns to about 25 microns.
